(19) United States
(12) Patent Application Publication
(10) Pub. No.: US 2026/0347974 A1
(43) Pub. Date: Nov. 5, 2026

(54) NON-ORIENTED ELECTRICAL STEEL SHEET AND METHOD FOR PRODUCING SAME

(71) Applicant: JFE STEEL CORPORATION, Tokyo (JP)

(72) Inventors: Hayato SAITO, Tokyo (JP); Tomoyuki OKUBO, Tokyo (JP); Yoshiaki ZAIZEN, Tokyo (JP); Shigehiro MARUYAMA, Tokyo (JP)

(73) Assignee: JFE STEEL CORPORATION, Tokyo (JP)

(21) Appl. No.: 19/118,132

(22) PCT Filed: Oct. 4, 2023
(86) PCT No.: PCT/JP2023/036145

§ 371 Date: Apr. 3, 2025

(30) Foreign Application Priority Data
Oct. 31, 2022 (JP) 2022-174022

(51) Int. Cl. C22C 38/02; C21D 1/18; C21D 1/74; C21D 1/84; C21D 6/00; C21D 8/1216; C21D 8/1244; C21D 9/46; C22C 38/00; C22C 38/04; C22C 38/06; C22C 38/08; C22C 38/10; C22C 38/12; C22C 38/14; C22C 38/16; C22C 38/20; C22C 38/22; C22C 38/28; C22C 38/30; C22C 38/34; C22C 38/42; C22C 38/44; C22C 38/50; C22C 38/52; C22C 38/54; C22C 38/60; H01F 1/147

(52) U.S. Cl. CPC C22C 38/02; C21D 1/18; C21D 1/74; C21D 1/84; C21D 6/001; C21D 6/002; C21D 6/004; C21D 6/005; C21D 6/007; C21D 6/008; C21D 8/1222; C21D 8/1233; C21D 8/1261; C21D 9/46; C22C 38/001; C22C 38/002; C22C 38/004; C22C 38/005; C22C 38/008; C22C 38/04; C22C 38/06; C22C 38/08; C22C 38/10; C22C 38/12; C22C 38/14; C22C 38/16; C22C 38/20; C22C 38/22; C22C 38/28; C22C 38/30; C22C 38/34; C22C 38/42; C22C 38/44; C22C 38/50; C22C 38/52; C22C 38/54; C22C 38/60; H01F 1/14775; C22C 2202/02

(57) ABSTRACT

A non-oriented electrical steel sheet having a yield strength at 150 °C of 300 MPa or more and a variation of the yield strength in a sheet width direction of 30 MPa or less is obtained by subjecting a steel slab containing, in mass %, C: 0.0005 to 0.0100%, Si: 2.0 to 4.5%, Mn: 0.1 to 2.0% and at least one of Sn and Sb: 0.01 to 0.20% in total to hot rolling, hot-band annealing, cold rolling and finishing annealing, wherein a soaking temperature and a soaking time in the finishing annealing are 700 to 1100 °C and 2 seconds or more, respectively, and a cooling rate in cooling from the soaking temperature to 200 °C of the in the finishing annealing, a composition and a dew point of an atmosphere gas, a variation of a temperature in a sheet width direction are controlled so as to satisfy the given conditions.

### TECHNICAL FIELD

This invention relates to a non-oriented electrical steel sheet having low iron loss and also having high strength at an operating temperature, and a method for producing the same.

### BACKGROUND ART

With the increasing demand for energy saving and reduction of carbon dioxide emissions, high efficiency has been strongly required in a variety of automobiles and electric equipment. Non-oriented electrical steel sheets used in an iron core of a motor have also been demanded to have excellent iron loss properties and higher strength from the viewpoint of durability. In this regard, if the steel sheet has variation of strength, the risk of breakage is increased in a low-strength portion of the sheet during use as an iron core, so that the strength in the steel sheet is required to be uniform. Further, driving motors for automobiles are required to be small in size and large in power, which increases the temperature during use of the motor, and hence the high strength is required even at about 150 °C. As described above, it is essential for the non-oriented electrical steel sheet used as an iron core to have not only excellent magnetic properties but also high yield strength in a high temperature range with minimal variability.

As the non-oriented electrical steel sheet having high yield strength, for example, Patent Literature 1 proposes a non-oriented electrical steel sheet having a chemical composition comprising Si: 1.5 mass % or more but 3.5 mass % or less, Mn: 1.5 mass % or less, Al: 0.2 mass % or more but 3.0 mass % or less, Mg: 0.0003 mass % or more but 0.0050 mass % or less, and the balance being Fe and inevitable impurities and having a high yield strength, wherein a crystal grain size d is 5 μm or more but 40 μm or less and the relationship of d≤50×(Si+0.5Al−2) is satisfied.

As the method for producing a non-oriented electrical steel sheet having uniform iron loss in the sheet width direction, for example, Patent Literature 2 proposes a method for producing a non-oriented electrical steel sheet having low iron loss, characterized in that a silicon steel slab containing C: 0.005 mass % or less, Si: 2.5 to 4.0 mass %, S: 0.005mass % or less, Al: 0.3 to 1.5 mass %, and N: 0.004 mass % or less is subjected to hot rolling, hot-band annealing, and one cold rolling step or two or more cold rolling steps with intermediate annealing between each step to obtain a final sheet thickness, soaked at temperatures of 900 to 1200 °C. for 5 seconds to 15 minutes, subjected to finishing annealing involving cooling the steel sheet until the temperature at the sheet width central portion reaches 600 °C. while the temperature across the sheet width direction is maintained within ±20 °C. of the temperature at the central portion, followed by insulation treatment.

As the method for producing a non-oriented electrical steel sheet having good magnetic properties, for example, Patent Literature 3 proposes a method for producing a non-oriented electrical steel sheet having excellent low-magnetic field properties, characterized by comprising (1) a step of producing a hot-rolled steel sheet by hot rolling a silicon steel slab having a chemical composition comprising C: 0.01 mass % or less, Si: 4 mass % or less, Mn: 0.1 to 0.8 mass %, Al: either 0.004 mass % or less or 0.1 to 1 mass %, Cu: 0.05 mass % or less (including 0), S: 0.015 mass % or less (including 0), N: 0.005 mass % or less (including 0), P: 0.2 mass % or less (including 0), and the balance being substantially Fe and inevitable impurities; (2) a step of producing a cold-rolled steel sheet by subjecting the hot-rolled steel sheet to one cold rolling step or two or more cold rolling steps; and (3) a step of subjecting the cold-rolled steel sheet to finishing annealing, the finishing annealing involving cooling the steel sheet from a soaking temperature to a rapid-cooling start temperature TS, which is in the temperature range of 600 °C to 500 °C, at an average cooling rate VS of 10 °C/s or less, and then rapid cooling the steel sheet at an average cooling rate VQ of 10 to 50 °C/s from the rapid-cooling start temperature TS to 300 °C.

### CITATION LIST

### Patent Literature

Patent Literature 1: JP-A-2005-113158
Patent Literature 2: JP-A-S63-047333
Patent Literature 3: JP-A-H09-302414

### SUMMARY OF INVENTION

### Technical Problem

However, as a result of the inventors' studies, the above prior arts have the following problems. In the technique disclosed in Patent Literature 1, the yield strength at room temperature is sufficiently high while that at 150 °C is not sufficient, and good iron loss cannot be obtained. In the technique disclosed in Patent Literature 2, although the variation of the iron loss in the sheet width direction can be reduced, the yield strength at 150 °C. tends to vary. In addition, the technique disclosed in Patent Literature 3 can achieve good magnetic properties, but the yield strength at 150 °C. decreases.

The invention has been contrived in view of the above problems of the prior arts, and an object thereof is to provide a non-oriented electrical steel sheet having not only good magnetic properties but also high yield strength at the operating temperature of a motor with minimal variation, and a production method advantageous thereto.

### Solution to Problem

In order to solve the above problems, the inventors have made intensive studies on the chemical composition of the steel sheet and the production method thereof, with particular emphasis on carbon C, which deteriorates iron loss and is usually reduced. As a result of the studies, the inventors found the following insight. That is, by properly controlling the cooling rate in a given temperature range, together with the composition and dew point of the atmosphere gas in a furnace during the cooling step of finishing annealing, the steel sheet can be cooled uniformly across its entire width. This ensures that the dissolution carbon remains uniform across the width of the steel sheet. Consequently, good iron loss is achieved and high yield strength at 150 °C, which is the operating temperature of the motor, is imparted with minimal variation in the sheet width direction. The present invention has thus been achieved.

The invention is a non-oriented electrical steel sheet with a chemical composition comprising C: 0.0005 to 0.0100 mass %, Si: 2.0 to 4.5 mass %, Mn: 0.1 to 2.0 mass %, P: 0.050 mass % or less, S: 0.0050 mass % or less, Al: 0.20 to 2.50 mass %, N: 0.0050 mass % or less, O: 0.0050 mass % or less, at least one of Sn and Sb: 0.01 to 0.20 mass % in total, and the balance being Fe and inevitable impurities, having a minimum value of yield strength at 150 °C in the sheet width direction of 300 MPa or more and a variation of the yield strength in the sheet width direction of 30 MPa or less.

In addition to the above chemical composition, the non-oriented electrical steel sheet according to the invention contains at least one group selected from the following groups A to F:
group A: at least one element selected from the group consisting of Ca, Mg, and REM: 0.0010 to 0.0080 mass % in total;
group B: at least one element selected from the group consisting of Cr, Mo, Cu, and Ni: 0.01 to 0.60 mass % in total;
group C: at least one element selected from the group consisting of Ti, Nb, and V: 0.0005 to 0.0050 mass % in total;
group D: at least one element selected from the group consisting of B: 0.0001 to 0.0020 mass %, Pb: 0.0001 to 0.0010 mass %, and W: 0.0005 to 0.0050 mass %;
group E: Zn: 0.001 to 0.010 mass %; and
group F: Co: 0.0010 to 0.0500 mass %.

The invention also proposes a method for producing a non-oriented electrical steel sheet including: hot rolling a steel slab having a chemical composition comprising C: 0.0005 to 0.0100 mass %, Si: 2.0 to 4.5 mass %, Mn: 0.1 to 2.0 mass %, P: 0.050 mass % or less, S: 0.0050 mass % or less, Al: 0.20 to 2.50 mass %, N: 0.0050 mass % or less, O: 0.0050 mass % or less, at least one of Sn and Sb: 0.01 to 0.20 mass % in total, and the balance being Fe and inevitable impurities, followed by hot-band annealing, cold rolling, and finishing annealing, in which
a soaking temperature and a soaking time in the finishing annealing are 700 to 1100 °C and 2 seconds or more, respectively, and
cooling is conducted from the soaking temperature to 200 °C in the finishing annealing while satisfying the following conditions (1) to (3):
(1) an average cooling rate in a temperature range from 700 °C to 200 °C: 10 °C/s or more;
(2) a hydrogen concentration in a furnace atmosphere gas from the soaking temperature to 700 °C: 1 vol % or more;
(3) a dew point of the furnace atmosphere gas in a temperature range from the soaking temperature to 300 °C: −30 °C or less; and
(4) a variation of a steel sheet temperature in a sheet width direction in a temperature range from 500 °C to 200 °C: 40 °C or less.

In the method for producing a non-oriented electrical steel sheet according to the invention, the cooling is conducted such that the difference between the maximum and minimum values of an average cooling rate every 100 °C in a temperature range from 700 °C to 200 °C during the finishing annealing is 20 °C/s or less.

The steel slab used in the method for producing a non-oriented electrical steel sheet according to the invention contains, in addition to the above chemical composition, at least one group selected from the following groups A to F:
group A: at least one element selected from the group consisting of Ca, Mg, and REM: 0.0010 to 0.0080 mass % in total;
group B: at least one element selected from the group consisting of Cr, Mo, Cu, and Ni: 0.01 to 0.60 mass % in total;
group C: at least one element selected from the group consisting of Ti, Nb, and V: 0.0005 to 0.0050 mass % in total;
group D: at least one element selected from the group consisting of B: 0.0001 to 0.0020 mass %, Pb: 0.0001 to 0.0010 mass %, and W: 0.0005 to 0.0050 mass %;
group E: Zn: 0.001 to 0.010 mass %; and
group F: Co: 0.0010 to 0.0500 mass %.

### Advantageous Effects of Invention

The present invention can stably provide a non-oriented electrical steel sheet not only having good magnetic properties but also having high yield strength over the entire width of the steel sheet at an operating temperature of a motor. Therefore, the present invention can provide a material suitable for use in a motor required to have high efficiency and high durability.

### DESCRIPTION OF EMBODIMENTS

Firstly, the reason for the limitation of the chemical composition to be provided in the non-oriented electrical steel sheet according to the invention will be described.

### C: 0.0005 to 0.0100 Mass %

In the invention, C is an element necessary to obtain high yield strength at 150 °C, which is the operating temperature of a motor. Dissolution C in a steel sheet product contributes to increasing yield strength as it causes dislocations in the steel sheet or be segregated in grain boundaries when heated to 150 °C. In order to achieve the above effect, C is necessary to be contained at 0.0005 mass % or more. On the other hand, an excessive C content causes such disadvantages that yield strength largely varies and iron loss deteriorates. Therefore, the C content is limited to 0.0100 mass % or less. It is preferably in the range of 0.0008 to 0.0060 mass %.

### Si: 2.0 to 4.5 Mass %

Si has an effect of increasing the specific resistance of steel and thus reducing iron loss, so that it is contained at 2.0 mass % or more in the present invention. Si also has an effect of increasing the yield strength. To achieve this effect, Si is preferably added at 2.7 mass % or more, particularly at more than 3.0 mass % for a high-quality material where low iron loss is highly required. However, when Si is added at more than 4.5 mass %, the yield strength varies greatly, and moreover, rolling becomes difficult due to the hardening of the steel. Therefore, the upper limit of Si content should be 4.5 mass %, preferably 4.0 mass %.

### Mn: 0.1 to 2.0 Mass %

Mn, similar to Si, is an element effective in increasing the specific resistance of steel to reduce iron loss and is therefore contained at 0.1 mass % or more, preferably 0.3 mass % or more. Meanwhile, when the Mn content exceeds 2.0 mass %, fine Mn carbide is formed to reduce dissolution C, thereby reducing the yield strength at 150 °C. Therefore, Mn is contained at 2.0 mass % or less, preferably 1.0 mass % or less.

### P: 0.050 Mass % or Less

P segregates at the grain boundary, causing embrittlement of steel. This leads to disadvantages such as the deterioration of rollability and increase in yield strength variation. Therefore, the P content should be 0.050 mass % or less, preferably 0.030 mass % or less, more preferably 0.015 mass % or less. The lower limit of P is not specified, but it is preferably about 0.004 mass %, from the viewpoint of suppressing the cost increase for removing P in the steelmaking process.

### S: 0.0050 Mass % or Less

S is a harmful element causing disadvantages such as affecting hot workability of steel and forming fine sulfide to thus refine crystal gains, leading to an increase in the variation of yield strength and deterioration of iron loss. Therefore, the S content is limited to 0.0050 mass % or less, preferably 0.0020 mass % or less.

### Al: 0.20 to 2.50 Mass %

Al, similar to Si, has an effect of increasing the specific resistance of steel to thus reduce iron loss and also has an effect of increasing the yield strength. Therefore, in the invention, Al is contained at 0.20 mass % or more, preferably 0.50 mass % or more. Meanwhile, when Al is excessively contained, the variation of yield strength increases or alumina is formed in a large amount to induce surface defects. Therefore, the upper limit of Al is 2.50 mass %, preferably at 2.20 mass % or less.

### N: 0.0050 Mass % or Less

N is a harmful element which forms fine nitride such as AlN, thus increasing yield strength variation and deteriorating iron loss. Therefore, the N content is limited to 0.0050 mass % or less, preferably 0.0030 mass % or less. In addition, the lower limit of N is not particularly specified but is preferably about 0.0005 mass % from the viewpoint of suppressing the cost increase in steelmaking.

### O: 0.0050 Mass % or Less

O is a harmful element which forms fine oxide, hindering crystal grain growth and deteriorating iron loss. Also, the fine oxide refines crystal grains, causing yield strength to vary. Therefore, the O content is limited to 0.0050 mass % or less, preferably 0.0025 mass % or less.

At least one of Sn and Sb: 0.01 to 0.20 mass % in total

Sn and Sb are elements effective in improving the texture of the steel sheet after finishing annealing to thus improve magnetic properties. Therefore, at least one of Sn and Sb is added at 0.01 mass % or more in total. Meanwhile, the above effect is saturated when Sn and Sb are added excessively, so that the total content of at least one of Sn and Sb should be 0.20 mass % or less. The total content is preferably in the range of 0.02 to 0.05 mass %.

The non-oriented electrical steel sheet according to the invention contains Fe and inevitable impurities as the balance other than the above elements. However, the steel sheet may contain at least one group selected from the following groups A to F to further improve the magnetic and strength properties.

Group A: at least one element selected from the group consisting of Ca, Mg, and REM: 0.0010 to 0.0080 mass % in total

Ca, Mg, and REM have an effect of fixing S as a sulfide to improve iron loss. Therefore, at least one element selected from the group consisting of Ca, Mg, and REM is preferably contained at 0.0010 mass % or more in total. Meanwhile, when Ca, Mg, and REM are contained excessively, inclusions is formed, and productivity deteriorates. Therefore, the contents of Ca, Mg, and REM are preferably 0.0080 mass % or more in total, more preferably in a range of 0.0015 to 0.0060 mass % in total.

Group B: at least one element selected from the group consisting of Cr, Mo, Cu, and Ni: 0.01 to 0.60 mass % in total

Cr, Mo, Cu, and Ni have an effect of increasing the specific resistance of steel to improve iron loss. Therefore, it is preferable to contain at least one of Cr, Mo, Cu, and Ni in a total content of 0.01 mass % or more. However, excessive contents of Cr, Mo, Cu, and Ni deteriorate the surface properties. Therefore, at least one element selected from the group consisting of Cr, Mo, Cu, and Ni is preferably contained in a total content of 0.60 mass % or less, and more preferably in a range of 0.03 to 0.50 mass % in total. It should be noted that Cu is preferably contained at 0.50 mass % or less as it largely affects the surface properties. Cu is more preferably contained at 0.10 mass % or less where severe surface properties are required.

Group C: at least one element selected from the group consisting of Ti, Nb, and V: 0.0005 to 0.0050 mass % in total

Ti, Nb, and V have an effect of forming precipitates to increase the yield strength. Therefore, at least one element selected from the group consisting of Ti, Nb, and V is preferably contained at 0.0005 mass % or more in total. Meanwhile, the excessive additions of Ti, Nb, and V hinders the crystal grain growth significantly and deteriorate iron loss. Therefore, at least one element selected from the group consisting of Ti, Nb, and V is preferably contained at 0.0050 mass % or less in total, more preferably in a range of 0.0010 to 0.0025 mass % in total.

Group D: at least one element selected from the group consisting of B: 0.0001 to 0.0020 mass %, Pb: 0.0001 to 0.0010 mass %, and W: 0.0005 to 0.0050 mass %

B, Pb, and W all have an effect of refining the texture of the steel sheet after finishing annealing, thereby increasing its yield strength. In order to achieve this effect, it is preferable to contain B and Pb at 0.0001 mass % or more each and W at 0.0005 mass % or more. Meanwhile, excessive contents of these elements not only saturate the above effect but also deteriorate iron loss. Therefore, when these elements are added, B, Pb, and W are preferably contained at 0.0020 mass % or less, 0.0010 mass % or less, and 0.0050 mass % or less, respectively. More preferably, B, Pb, and W are contained in the ranges of 0.0003 to 0.0010 mass %, 0.0002 to 0.0006 mass %, and 0.0020 to 0.0035 mass %, respectively.

### Group E: Zn: 0.001 to 0.010 Mass %

Zn has an effect of forming an oxide or a sulfide and refining the texture of the steel sheet, thereby increasing the yield strength. In order to achieve this effect, Zn is preferably added at 0.001 mass % or more. Meanwhile, excessive addition of Zn can deteriorate iron loss. Therefore, Zn is preferably contained at 0.010 mass % or less when added. It is more preferably contained in the range of 0.003 to 0.006 mass %.

### Group F: Co: 0.0010 to 0.0500 Mass %

Co has effects such as increasing the specific resistance of steel to reduce its iron loss and increasing its yield strength. In order to obtain these effects, Co is preferably contained at 0.0010 mass % or more. Meanwhile, excessive addition of Co only saturates the effect, so that Co is preferably contained at 0.0500 mass % or less, more preferably in the range of 0.0040 to 0.0200 mass %.

The mechanical strength properties of the non-oriented electrical steel sheet according to the present invention will be described.
Minimum value of yield strength at 150 °C in sheet width direction: 300 MPa or more

Recently, the temperature (operating temperature) of the motor in use has been increasing, requiring durability at the level of 150 °C. Therefore, in order to maintain high yield strength even at this temperature, the yield strength at 150 °C is defined as 300 MPa or more, preferably 340 MPa or more in the present invention. Here, the yield strength at 150 °C is the minimum value of the yield strength values (upper yield point or 0.2% proof stress if there is no upper yield point) measured in accordance with JIS Z2241 for test specimens taken from 10 or more positions in the sheet width direction of the steel sheet.
Variation of yield strength at 150 °C in sheet width direction: 30 MPa or less

Even though the value of the minimum value of yield strength in the sheet width direction is high, large variations in yield strength may cause the portion of low yield strength to become a starting point of breakage. Therefore, in the invention, the variation of yield strength at 150 °C in the sheet width direction is limited to 30 MPa or less. Here, the variation of yield strength in the sheet width direction means a difference between the maximum value and the minimum value when the yield strength is measured at 10 or more positions in the width direction of the steel sheet.

The method for producing a non-oriented electrical steel sheet according to the invention will be described.

### Raw Steel Material (Slab)

The raw steel material (slab) used in the production of a non-oriented electrical steel sheet according to the invention needs to be adjusted to have the above-described chemical composition. Methods of melting steel having the chemical composition include well-known refining processes using a converter, an electric furnace, or a secondary refining apparatus such as a vacuum degassing apparatus or the like, and are not particularly specified. A continuous casting method is preferably used to produce the slab, but an ingot making-blooming method and a thin slab casting method are acceptable. The raw material may be an iron scrap and a direct reduced iron.

### Hot Rolling

The steel slab is heated to a given temperature and hot rolled to form a hot-rolled sheet of a given thickness. The hot rolling conditions are not specified, but the heating temperature of the slab is preferably in the range of 1000 °C to 1160 °C, inclusive. In addition, the slab may be subjected to direct rolling in which the slab is hot-rolled immediately after continuous casting without heating. The winding temperature of a coil after hot rolling is preferably in the range of 500 °C to 650 °C, inclusive.

### Hot-Band Annealing

The steel sheet (hot-rolled sheet) after the hot rolling is then subjected to hot-band annealing. The conditions of the hot-band annealing are not specified, but the annealing temperature is preferably in the range of 800 to 1000 °C, inclusive. It is also preferable to remove scales formed on the surface of steel sheet by pickling in a pre-stage or post-stage of the hot-band annealing. The pickling may be conducted in a usual manner and is not specified.

### Cold Rolling

The steel sheet after the hot-band annealing is then subjected to one cold rolling step or two or more cold rolling steps with an intermediate annealing between each step to obtain a cold-rolled sheet having a final sheet thickness (product sheet thickness). The cold rolling condition is not specified as long as the final sheet thickness is obtained. The final sheet thickness is preferably 0.35 mm or less in order to reduce iron loss.

### Finishing Annealing

The cold rolled sheet with the final sheet thickness then undergoes finishing annealing to impart the desired magnetic and strength properties. Finishing annealing is the most important step in the invention and needs to be conducted under the following conditions.

Soaking temperature: 700 to 1100 °C, soaking time: 2 seconds or more

When the soaking temperature of the finishing annealing is lower than 700 °C, recrystallization is not sufficiently induced, and good magnetic properties are not obtained. Preferably, it should be 800 °C or higher. On the other hand, when it is higher than 1100 °C, the steel sheet texture is coarsened, reducing the yield strength and preventing the desired strength from being obtained. Preferably, it should be 1050 °C or lower. The soaking time during which the above soaking temperature is maintained needs to be 2 seconds or more to heat the sheet uniformly in the width direction. It is preferably 5 seconds or more, and more preferably 10 seconds or more. The upper limit of the soaking time is preferably about 60 seconds from the viewpoint of suppressing the deterioration of yield strength due to the coarsening of the steel sheet texture.

Cooling rate in a temperature range from 700 °C to 200 °C: 10 °C/s or more

In the cooling process after soaking, the steel sheet is cooled at a given cooling rate uniformly in the sheet width direction, so that dissolution C remains uniform in the sheet width direction, thereby increasing the yield strength at 150 °C and reducing the variation thereof in the sheet width direction. However, when the cooling rate from 700 °C to 200 °C falls below 10 °C/s, C is precipitated as Fe carbide during cooling to reduce amount of dissolution C, and thus the high yield strength at 150 °C is not obtained. Therefore, the cooling rate from 700 °C to 200 °C is required to 10 °C/s or more. In order to further increase the yield strength at 150 °C, it is preferably 15 °C/s or more. Meanwhile, when the cooling rate is too large, it is difficult to control the temperature uniformly in the sheet width direction, which increases the variation of the yield strength in the sheet width direction and reduces the magnetic properties due to cooling strain. Therefore, the upper limit is preferably about 50 °C/s.
Hydrogen concentration of atmosphere gas in furnace from soaking temperature to 700 °C: 1 vol % or more

In the high temperature range of the steel sheet from the soaking temperature to 700 °C, when the hydrogen concentration of the atmosphere gas in the furnace is less than 1 vol %, the surface of the steel sheet is oxidized non-uniformly, forming an oxide film. This causes a difference in the heat exchange with a cooling gas and promotes the temperature variation in the sheet width direction. From such a viewpoint, the hydrogen concentration of the atmosphere gas in the furnace from the soaking temperature to 700 °C needs to be 1 vol % or more in the invention. From the viewpoint of increasing heat conduction of the atmosphere gas to reduce the temperature variation of the steel sheet in the width direction, it is preferably 5 vol % or more, more preferably 8 vol % or more. However, when the hydrogen concentration is increased too high, not only is the above effect saturated, but the cost of the atmosphere gas also increases, so that the upper limit is preferably about 30 vol %.
Dew point of atmosphere gas in furnace in temperature range from soaking temperature to 300 °C: −30 °C or less

If the dew point of the atmosphere gas in the furnace is high in the range where the steel sheet temperature is between the soaking temperature and 300 °C, the surface layer of the steel sheet is oxidized non-uniformly to form an oxide film, which causes a difference in heat exchange with the cooling gas and promotes the temperature variation in the sheet width direction. Therefore, the dew point of the atmosphere gas in the furnace in the temperature range from the soaking temperature to 300 °C should be −30 °C or less, preferably −40 °C or less. Considering that the effect saturates if the dew point of the furnace atmosphere gas is too low, and taking into account the dew point of industrially usable atmosphere gases, the lower limit is preferably about −70 °C.
Variation of steel sheet temperature in temperature range from 500 °C to 200 °C in sheet width direction: 40 °C or less

When the variation of the steel sheet temperature in the sheet width direction in the temperature range of 500 to 200 °C is large, the amount of dissolution C in the sheet width direction is varied, which may increase the variation of yield strength at 150 °C in the sheet width direction. Therefore, the variation of the steel sheet temperature between 50° and 200 °C in the sheet width direction should be limited to 40 °C or less. Preferably, it should be 30 °C or less. Here, the variation of the steel sheet temperature in the sheet width direction is the difference between the maximum and minimum temperatures in the sheet width direction at positions excluding 10 mm from the widthwise edges.
Difference between maximum and minimum values of average cooling rate every 100 °C in temperature range from 700 °C to 200 °C: 20 °C/s or less

When the average cooling rate every 100 °C is largely varied during the cooling after soaking in finishing annealing, the temperature variation in the sheet width direction may be promoted. Therefore, it is preferable to keep the cooling rate in cooling between 70° and 200 °C as uniform as possible. Specifically, it is preferable to control the difference between the maximum minimum values of the average cooling rate every 100 °C in the range where the steel sheet temperature is between 700 °C and 200 °C to 20 °C/s or less. More preferably, it should be 10 °C/s or less.

Thereafter, the steel sheet subjected to the finishing annealing as described above is coated with an insulating film, if required, to form a product sheet. The insulating film may be an inorganic film, organic film or mixture of inorganic and organic films and is not specified.

### Examples

A steel having a chemical composition comprising various elements shown in Table 1 and the balance being Fe and inevitable impurities is melted by a usual refining process and produced into a raw steel material (slab) by a continuous casting method. The slab is then heated to 1130 °C in a heating furnace for 60 minutes and subjected to hot rolling involving rough rolling and finish rolling to form a hot-rolled sheet of a sheet thickness of 1.8 mm, which was wound into a coil at 550 °C. The hot-rolled sheet is subjected to hot-band annealing at a soaking temperature of 960 °C and cold rolled to form a cold-rolled sheet of a final sheet thickness of 0.30 mm. The cold-rolled sheet is then subjected to finishing annealing under various conditions shown in Table 2 to form a product sheet.

TABLE 1-1

| Steel | Chemical composition (mass %) | | | | | | | | | | | |
|---|---|---|---|---|---|---|---|---|---|---|---|---|
| symbol | C | Si | Mn | P | S | Al | N | O | Sn | Sb | Others | Remarks |
| A | 0.0023 | 2.7 | 0.5 | 0.012 | 0.0015 | 0.7 | 0.0018 | 0.0013 | 0.02 | — | — | Invention steel |
| B | 0.0022 | 2.8 | 0.8 | 0.010 | 0.0012 | 1.4 | 0.0017 | 0.0010 | 0.05 | — | — | Invention steel |
| C | 0.0035 | 3.5 | 0.1 | 0.008 | 0.0006 | 0.7 | 0.0021 | 0.0014 | — | 0.02 | — | Invention steel |
| D | 0.0060 | 3.8 | 0.5 | 0.012 | 0.0020 | 0.6 | 0.0026 | 0.0016 | 0.03 | 0.02 | — | Invention steel |
| E | 0.0023 | 3.2 | 0.5 | 0.012 | 0.0015 | 0.7 | 0.0018 | 0.0013 | 0.01 | — | Ca: 0.005 | Invention steel |
| F | 0.0023 | 2.5 | 0.5 | 0.015 | 0.0020 | 2.5 | 0.0005 | 0.0012 | 0.03 | — | Mg: 0.003 | Invention steel |
| G | 0.0023 | 3.2 | 0.5 | 0.012 | 0.0015 | 0.7 | 0.0024 | 0.0015 | 0.02 | 0.01 | REM: 0.006 | Invention steel |
| H | 0.0023 | 3.4 | 0.5 | 0.020 | 0.0015 | 0.7 | 0.0018 | 0.0020 | 0.02 | — | Cr: 0.2 | Invention steel |
| I | 0.0024 | 3.0 | 0.5 | 0.013 | 0.0015 | 0.7 | 0.0019 | 0.0013 | 0.10 | 0.10 | Mo: 0.02 | Invention steel |
| J | 0.0023 | 3.2 | 0.5 | 0.012 | 0.0015 | 0.7 | 0.0036 | 0.0009 | — | 0.04 | Cu: 0.1 | Invention steel |
| K | 0.0020 | 3.2 | 0.5 | 0.015 | 0.0035 | 0.7 | 0.0016 | 0.0016 | 0.02 | — | Ni: 0.3 | Invention steel |
| L | 0.0018 | 3.2 | 0.5 | 0.016 | 0.0015 | 0.7 | 0.0014 | 0.0013 | 0.02 | — | Cu: 0.5, Ni: 0.2 | Invention steel |
| M | 0.0026 | 3.2 | 0.5 | 0.004 | 0.0015 | 0.7 | 0.0016 | 0.0014 | 0.02 | — | Ti: 0.0012 | Invention steel |
| N | 0.0024 | 3.2 | 0.5 | 0.007 | 0.0015 | 0.7 | 0.0012 | 0.0017 | 0.02 | — | Nb: 0.0005 | Invention steel |
| O | 0.0017 | 3.2 | 0.5 | 0.013 | 0.0015 | 0.7 | 0.0009 | 0.0016 | 0.02 | — | V: 0.0010 | Invention steel |
| P | 0.0006 | 3.2 | 0.5 | 0.012 | 0.0015 | 0.7 | 0.0021 | 0.0013 | 0.02 | — | B: 0.0006 | Invention steel |
| Q | 0.0004 | 2.8 | 0.5 | 0.012 | 0.0015 | 0.7 | 0.0014 | 0.0014 | 0.02 | — | — | Comparative steel |
| R | 0.0021 | 1.5 | 0.5 | 0.013 | 0.0013 | 0.7 | 0.0015 | 0.0014 | 0.02 | — | — | Comparative steel |
| S | 0.0022 | 2.5 | 0.5 | 0.012 | 0.0014 | 0.1 | 0.0016 | 0.0016 | 0.02 | — | — | Comparative steel |
| T | 0.0022 | 4.0 | 0.8 | 0.012 | 0.0016 | 0.5 | 0.0012 | 0.0009 | 0.02 | 0.01 | — | Invention steel |
| U | 0.0019 | 4.5 | 0.8 | 0.013 | 0.0015 | 0.2 | 0.0022 | 0.0014 | 0.02 | — | — | Invention steel |
| V | 0.0015 | 3.2 | 1.5 | 0.015 | 0.0006 | 1.2 | 0.0026 | 0.0008 | 0.02 | — | — | Invention steel |
| W | 0.0031 | 3.4 | 2.0 | 0.012 | 0.0012 | 0.7 | 0.0018 | 0.0012 | 0.02 | — | — | Invention steel |

TABLE 1-2

| Steel | Chemical composition (mass %) | | | | | | | | | | | |
|---|---|---|---|---|---|---|---|---|---|---|---|---|
| symbol | C | Si | Mn | P | S | Al | N | O | Sn | Sb | Others | Remarks |
| X | 0.015 | 3.0 | 0.5 | 0.017 | 0.0019 | 0.7 | 0.0019 | 0.0013 | 0.02 | — | — | Comparative steel |
| Y | 0.0026 | 5.0 | 0.5 | 0.009 | 0.0016 | 0.7 | 0.0014 | 0.0008 | 0.02 | — | — | Comparative steel |
| Z | 0.0019 | 2.3 | 0.04 | 0.014 | 0.0017 | 0.7 | 0.0022 | 0.0009 | 0.02 | — | — | Comparative steel |
| AA | 0.0014 | 2.3 | 2.2 | 0.015 | 0.0016 | 0.8 | 0.0018 | 0.0014 | 0.02 | — | — | Comparative steel |
| AB | 0.0023 | 3.4 | 1.0 | 0.060 | 0.0009 | 0.8 | 0.0021 | 0.0012 | — | 0.02 | — | Comparative steel |
| AC | 0.0028 | 3.2 | 0.5 | 0.013 | 0.0060 | 0.8 | 0.0012 | 0.0009 | 0.02 | — | — | Comparative steel |
| AD | 0.0027 | 3.2 | 0.6 | 0.014 | 0.0014 | 2.8 | 0.0014 | 0.0013 | 0.02 | — | — | Comparative steel |
| AE | 0.0021 | 3.0 | 0.5 | 0.015 | 0.0016 | 0.7 | 0.0060 | 0.0014 | 0.02 | — | — | Comparative steel |
| AF | 0.0016 | 2.8 | 0.5 | 0.011 | 0.0016 | 0.3 | 0.0016 | 0.0060 | 0.02 | — | — | Comparative steel |
| AG | 0.0018 | 3.2 | 0.5 | 0.004 | 0.0015 | 0.7 | 0.0032 | 0.0018 | 0.02 | — | Zn: 0.004 | Invention steel |
| AH | 0.0014 | 3.2 | 0.5 | 0.004 | 0.0015 | 0.7 | 0.0014 | 0.0012 | 0.02 | — | Pb: 0.0002 | Invention steel |
| AI | 0.0032 | 3.2 | 0.5 | 0.004 | 0.0015 | 0.7 | 0.0023 | 0.0011 | 0.02 | — | W: 0.002 | Invention steel |
| AJ | 0.0021 | 3.2 | 0.5 | 0.004 | 0.0015 | 0.7 | 0.0022 | 0.0014 | 0.02 | — | Co: 0.0085 | Invention steel |
| AK | 0.0019 | 3.2 | 0.5 | 0.013 | 0.0015 | 0.7 | 0.0031 | 0.0016 | 0.02 | — | Ca: 0.003, Mo: 0.02 | Invention steel |
| AL | 0.0022 | 3.2 | 0.5 | 0.015 | 0.0015 | 0.7 | 0.0026 | 0.0014 | 0.02 | — | Ca: 0.003, Cr: 0.05, Ti: 0.0015 | Invention steel |
| AM | 0.0016 | 3.2 | 0.5 | 0.01 | 0.0015 | 0.7 | 0.0024 | 0.0021 | 0.02 | — | Mg: 0.001, Cu: 0.15, Ti: 0.0019, | Invention steel |
| | | | | | | | | | | | B: 0.0003 | |
| AN | 0.0014 | 3.2 | 0.5 | 0.013 | 0.0015 | 0.7 | 0.0023 | 0.0013 | 0.02 | — | Cr: 0.10, Mo: 0.03, Ti: 0.0025 | Invention steel |
| AO | 0.0015 | 3.2 | 0.5 | 0.012 | 0.0015 | 0.7 | 0.0014 | 0.0015 | 0.02 | — | Cu: 0.12, Ni: 0.05, B: 0.0005 | Invention steel |
| AP | 0.0026 | 3.2 | 0.5 | 0.013 | 0.0015 | 0.7 | 0.0023 | 0.0017 | 0.02 | — | Ca: 0.004, Cr: 0.04, Pb: 0.0004 | Invention steel |
| AQ | 0.0019 | 3.2 | 0.5 | 0.008 | 0.0015 | 0.7 | 0.0024 | 0.0022 | 0.02 | — | V: 0.004, Co: 0.006 | Invention steel |
| AR | 0.0024 | 3.2 | 0.5 | 0.01 | 0.0015 | 0.7 | 0.0014 | 0.0019 | 0.02 | — | Cu: 0.13, Cr: 0.03, W: 0.002, | Invention steel |
| | | | | | | | | | | | Co: 0.010 | |
| AS | 0.0012 | 3.2 | 0.5 | 0.012 | 0.0015 | 0.7 | 0.0018 | 0.0014 | 0.02 | — | Cu: 0.08, Mo: 0.02, Nb: 0.0013, | Invention steel |
| | | | | | | | | | | | Zn: 0.003 | |
| AT | 0.0023 | 3.2 | 0.5 | 0.012 | 0.0015 | 0.7 | 0.0019 | 0.0008 | 0.02 | — | Ca: 0.002, Cu: 0.16, Ni: 0.05, | Invention steel |
| | | | | | | | | | | | Cr: 0.11, Ti: 0.0023, B: 0.0004, | |
| | | | | | | | | | | | Zn: 0.005, Pb: 0.006, W: 0.0031, | |
| | | | | | | | | | | | Co: 0.009 | |

A sample material is taken from the thus-obtained product sheet and subjected to the following evaluation test.

### <Magnetic Properties>

Test specimens 30 mm wide and 280 mm long were taken from the width central portion of the sample material such that the length direction of specimens was the L-direction (rolling direction) or the C-direction (direction perpendicular to the rolling direction), and the iron loss W 10/400 for each specimen was measured according to JIS C2550-1.

### <Yield Strength at 150 °C.>

Twenty pieces of JIS No. 5 test specimens were taken from the above sample material in the sheet width direction such that the tensile direction was along the L-direction (rolling direction), and heated to 150 °C in a constant temperature reservoir disposed in a tensile testing machine, held for 10 minutes and then subjected to a tensile test according to JIS Z2241 to measure the yield strength at 150 °C. For test specimens showing an upper yield point, the yield strength was the upper yield point. For test specimens that did not show an upper yield point, the 0.2% proof strength was considered the yield strength. The yield strength of the steel sheet was determined as the minimum value among 20 test specimens. A video-type elongation meter was used to measure strain (elongation) during the tensile test. Additionally, the variation of yield strength across the sheet width was defined as the difference between the maximum and minimum values of the yield strength among the 20 test specimens.

The evaluation test results are also shown in Table 2. It shows that the steel sheets of the invention examples produced under the conditions adapted to the present invention have a yield strength at 150 °C of 300 MPa or more, a variation of the yield strength in the sheet width direction of 30 MPa or less, and good magnetic properties such that iron loss W_{10/400} is 15.0 W/kg or less.

TABLE 2-1

| | | Finishing annealing conditions | | | | | | | | | | |
|---|---|---|---|---|---|---|---|---|---|---|---|---|
| | | | | Average | Hydrogen | | | | | | | |
| | | | | cooling | concentra- | Dew point | | | Steel sheet properties | | | |
| | | | | rate | tion (vol %) | (°C) | Temperature | | Yield | | | |
| | | Soaking | | (°C/s) | between | between | variation | Cooling | strength | Yield | Iron | |
| Steel | | temper- | Soaking | between | soaking | soaking | (°C) in | rate | (MPa) | strength | loss | |
| sheet | Steel | ature | time | 700 and | temperature | temperature | sheet width | variation | at | variation | W_{10/400} | |
| No | symbol | (°C) | (s) | 200 °C | and 700 °C | and 300 °C | direction | (°C/s) | 150 °C | (MPa) | (W/kg) | Remarks |
| 1 | A | 1000 | 10 | 15 | 10 | −50 | 21 | 10 | 320 | 13 | 14.3 | Invention |
| | | | | | | | | | | | | Example |
| 2 | A | 1000 | 10 | 5 | 10 | −50 | 23 | 10 | 285 | 22 | 14.1 | Comparative |
| | | | | | | | | | | | | Example |
| 3 | A | 1000 | 10 | 15 | 0.3 | −50 | 52 | 10 | 315 | 36 | 14.3 | Comparative |
| | | | | | | | | | | | | Example |
| 4 | A | 1000 | 10 | 15 | 8 | −20 | 46 | 10 | 322 | 34 | 14.6 | Comparative |
| | | | | | | | | | | | | Example |
| 5 | B | 1020 | 10 | 15 | 10 | −50 | 20 | 10 | 330 | 12 | 13.9 | Invention |
| | | | | | | | | | | | | Example |
| 6 | C | 980 | 10 | 20 | 10 | −50 | 23 | 10 | 410 | 13 | 13.3 | Invention |
| | | | | | | | | | | | | Example |
| 7 | D | 1000 | 10 | 20 | 15 | −50 | 26 | 10 | 435 | 22 | 13.1 | Invention |
| | | | | | | | | | | | | Example |
| 8 | E | 1050 | 10 | 15 | 15 | −50 | 11 | 10 | 355 | 12 | 13.4 | Invention |
| | | | | | | | | | | | | Example |
| 9 | F | 1080 | 10 | 15 | 1 | −45 | 25 | 10 | 376 | 9 | 13.5 | Invention |
| | | | | | | | | | | | | Example |
| 10 | G | 1000 | 10 | 35 | 10 | −40 | 31 | 20 | 403 | 28 | 13.6 | Invention |
| | | | | | | | | | | | | Example |
| 11 | H | 1000 | 10 | 15 | 10 | −50 | 22 | 10 | 392 | 16 | 13.4 | Invention |
| | | | | | | | | | | | | Example |
| 12 | I | 950 | 10 | 15 | 10 | −30 | 23 | 10 | 362 | 13 | 14.2 | Invention |
| | | | | | | | | | | | | Example |
| 13 | J | 1000 | 10 | 10 | 10 | −50 | 18 | 10 | 356 | 15 | 13.8 | Invention |
| | | | | | | | | | | | | Example |
| 14 | K | 1000 | 10 | 15 | 10 | −50 | 22 | 10 | 374 | 14 | 13.7 | Invention |
| | | | | | | | | | | | | Example |
| 15 | L | 1000 | 10 | 15 | 10 | −50 | 24 | 10 | 380 | 14 | 13.6 | Invention |
| | | | | | | | | | | | | Example |
| 16 | M | 1000 | 10 | 15 | 10 | −50 | 14 | 10 | 392 | 12 | 14.3 | Invention |
| | | | | | | | | | | | | Example |
| 17 | N | 1000 | 10 | 15 | 10 | −50 | 16 | 10 | 384 | 16 | 14.6 | Invention |
| | | | | | | | | | | | | Example |
| 18 | O | 1000 | 10 | 15 | 10 | −50 | 19 | 10 | 386 | 17 | 14.4 | Invention |
| | | | | | | | | | | | | Example |
| 19 | P | 1000 | 10 | 15 | 10 | −50 | 21 | 10 | 379 | 18 | 14.5 | Invention |
| | | | | | | | | | | | | Example |
| 20 | A | 700 | 2 | 15 | 10 | −50 | 36 | 10 | 460 | 28 | 14.6 | Invention |
| | | | | | | | | | | | | Example |
| 21 | A | 800 | 30 | 15 | 10 | −50 | 31 | 10 | 370 | 24 | 14.8 | Invention |
| | | | | | | | | | | | | Example |
| 22 | Q | 1000 | 10 | 15 | 10 | −50 | 18 | 10 | 290 | 18 | 14.6 | Comparative |
| | | | | | | | | | | | | Example |
| 23 | R | 1000 | 10 | 15 | 10 | −50 | 22 | 10 | 220 | 14 | 16.3 | Comparative |
| | | | | | | | | | | | | Example |
| 24 | S | 1000 | 10 | 15 | 10 | −50 | 23 | 10 | 260 | 15 | 15.4 | Comparative |
| | | | | | | | | | | | | Example |
| 25 | A | 650 | 10 | 15 | 10 | −50 | 24 | 10 | 510 | 36 | 18.6 | Comparative |
| | | | | | | | | | | | | Example |
| 26 | A | 1200 | 10 | 15 | 10 | −50 | 18 | 10 | 280 | 14 | 13.8 | Comparative |
| | | | | | | | | | | | | Example |
| 27 | A | 950 | 1 | 15 | 10 | −50 | 42 | 10 | 342 | 39 | 14.8 | Comparative |
| | | | | | | | | | | | | Example |
| 28 | A | 1000 | 10 | 15 | 10 | −50 | 39 | 30 | 310 | 29 | 14.5 | Invention |
| | | | | | | | | | | | | Example |

TABLE 2-2

| | | Finishing annealing conditions | | | | | | | | | | |
|---|---|---|---|---|---|---|---|---|---|---|---|---|
| | | | | Average | Hydrogen | | | | | | | |
| | | | | cooling | concentra- | Dew point | | | Steel sheet properties | | | |
| | | | | rate | tion (vol %) | (°C) | Temperature | | Yield | | | |
| | | Soaking | | (°C/s) | between | between | variation | Cooling | strength | Yield | Iron | |
| Steel | | temper- | Soaking | between | soaking | soaking | (°C) in | rate | (MPa) | strength | loss | |
| sheet | Steel | ature | time | 700 and | temperature | temperature | sheet width | variation | at | variation | W_{10/400} | |
| No | symbol | (°C) | (s) | 200 °C | and 700 °C | and 300 °C | direction | (°C/s) | 150 °C | (MPa) | (W/kg) | Remarks |
| 29 | T | 1000 | 10 | 15 | 10 | −50 | 22 | 10 | 446 | 16 | 12.8 | Invention |
| | | | | | | | | | | | | Example |
| 30 | U | 1000 | 10 | 15 | 10 | −50 | 24 | 10 | 490 | 21 | 12.2 | Invention |
| | | | | | | | | | | | | Example |
| 31 | V | 1000 | 10 | 15 | 10 | −50 | 19 | 10 | 431 | 19 | 13.1 | Invention |
| | | | | | | | | | | | | Example |
| 32 | W | 1000 | 10 | 15 | 10 | −50 | 16 | 10 | 448 | 14 | 12.9 | Invention |
| | | | | | | | | | | | | Example |
| 33 | X | 1000 | 10 | 15 | 10 | −50 | 19 | 10 | 471 | 45 | 20.4 | Comparative |
| | | | | | | | | | | | | Example |
| 34 | Y | 1000 | 10 | 15 | 10 | −50 | 29 | 10 | 590 | 39 | 11.8 | Comparative |
| | | | | | | | | | | | | Example |
| 35 | Z | 1000 | 10 | 15 | 10 | −50 | 20 | 10 | 270 | 19 | 15.4 | Comparative |
| | | | | | | | | | | | | Example |
| 36 | AA | 1000 | 10 | 15 | 10 | −50 | 23 | 10 | 284 | 34 | 15.2 | Comparative |
| | | | | | | | | | | | | Example |
| 37 | AB | 1000 | 10 | 15 | 10 | −50 | 21 | 10 | 457 | 37 | 13.7 | Comparative |
| | | | | | | | | | | | | Example |
| 38 | AC | 1000 | 10 | 15 | 10 | −50 | 20 | 10 | 394 | 38 | 18.6 | Comparative |
| | | | | | | | | | | | | Example |
| 39 | AD | 1000 | 10 | 15 | 10 | −50 | 34 | 10 | 580 | 39 | 12.7 | Comparative |
| | | | | | | | | | | | | Example |
| 40 | AE | 1000 | 10 | 15 | 10 | −50 | 26 | 10 | 435 | 35 | 16.8 | Comparative |
| | | | | | | | | | | | | Example |
| 41 | AF | 1000 | 10 | 15 | 10 | −50 | 24 | 10 | 390 | 32 | 18.3 | Comparative |
| | | | | | | | | | | | | Example |
| 42 | AG | 1000 | 10 | 15 | 10 | −50 | 22 | 10 | 364 | 13 | 13.5 | Invention |
| | | | | | | | | | | | | Example |
| 43 | AH | 1000 | 10 | 15 | 10 | −50 | 22 | 10 | 370 | 12 | 13.6 | Invention |
| | | | | | | | | | | | | Example |
| 44 | AI | 1000 | 10 | 15 | 10 | −50 | 22 | 10 | 369 | 15 | 13.9 | Invention |
| | | | | | | | | | | | | Example |
| 45 | AJ | 1000 | 10 | 15 | 10 | −50 | 22 | 10 | 381 | 16 | 13.2 | Invention |
| | | | | | | | | | | | | Example |
| 46 | AK | 1000 | 10 | 15 | 10 | −50 | 22 | 10 | 360 | 15 | 13.1 | Invention |
| | | | | | | | | | | | | Example |
| 47 | AL | 1000 | 10 | 15 | 10 | −50 | 22 | 10 | 403 | 16 | 13.2 | Invention |
| | | | | | | | | | | | | Example |
| 48 | AM | 1000 | 10 | 15 | 10 | −50 | 22 | 10 | 420 | 16 | 13.4 | Invention |
| | | | | | | | | | | | | Example |
| 49 | AN | 1000 | 10 | 15 | 10 | −50 | 22 | 10 | 412 | 13 | 13.1 | Invention |
| | | | | | | | | | | | | Example |
| 50 | AO | 1000 | 10 | 15 | 10 | −50 | 22 | 10 | 384 | 14 | 13.3 | Invention |
| | | | | | | | | | | | | Example |
| 51 | AP | 1000 | 10 | 15 | 10 | −50 | 22 | 10 | 376 | 14 | 13.1 | Invention |
| | | | | | | | | | | | | Example |
| 52 | AQ | 1000 | 10 | 15 | 10 | −50 | 22 | 10 | 382 | 17 | 13.8 | Invention |
| | | | | | | | | | | | | Example |
| 53 | AR | 1000 | 10 | 15 | 10 | −50 | 22 | 10 | 389 | 16 | 13.5 | Invention |
| | | | | | | | | | | | | Example |
| 54 | AS | 1000 | 10 | 15 | 10 | −50 | 22 | 10 | 396 | 16 | 13.6 | Invention |
| | | | | | | | | | | | | Example |
| 55 | AT | 1000 | 10 | 15 | 10 | −50 | 22 | 10 | 438 | 18 | 13.0 | Invention |
| | | | | | | | | | | | | Example |

1. A non-oriented electrical steel sheet with a chemical composition comprising C: 0.0005 to 0.0100 mass %, Si: 2.0 to 4.5 mass %, Mn: 0.1 to 2.0 mass %, P: 0.050 mass % or less, S: 0.0050 mass % or less, Al: 0.20 to 2.50 mass %, N: 0.0050 mass % or less, O: 0.0050 mass % or less, at least one of Sn and Sb: 0.01 to 0.20 mass % in total, and the balance being Fe and inevitable impurities, having
a minimum value of yield strength at 150 °C in the sheet width direction of 300 MPa or more, and
a variation of the yield strength in the sheet width direction of 30 MPa or less.

2. The non-oriented electrical steel sheet according to claim 1, which includes, in addition to the above chemical composition, at least one group selected from the following groups A to F:
group A: at least one element selected from the group consisting of Ca, Mg, and REM: 0.0010 to 0.0080 mass % in total;
group B: at least one element selected from the group consisting of Cr, Mo, Cu, and Ni: 0.01 to 0.60 mass % in total;
group C: at least one element selected from the group consisting of Ti, Nb, and V: 0.0005 to 0.0050 mass % in total;
group D: at least one element selected from the group consisting of B: 0.0001 to 0.0020 mass %, Pb: 0.0001 to 0.0010 mass %, and W: 0.0005 to 0.0050 mass %;
group E: Zn: 0.001 to 0.010 mass %; and
group F: Co: 0.0010 to 0.0500 mass %.

3. A method for producing a non-oriented electrical steel sheet comprising
hot rolling a steel slab having a chemical composition comprising C: 0.0005 to 0.0100 mass %, Si: 2.0 to 4.5 mass %, Mn: 0.1 to 2.0 mass %, P: 0.050 mass % or less, S: 0.0050 mass % or less, Al: 0.20 to 2.50 mass %, N: 0.0050 mass % or less, O: 0.0050 mass % or less, at least one of Sn and Sb: 0.01 to 0.20 mass % in total, and the balance being Fe and inevitable impurities, followed by hot-band annealing, cold rolling, and finishing annealing,
characterized in that
a soaking temperature and a soaking time in the finishing annealing are 700 to 1100 °C and 2 seconds or more, respectively, and
cooling is conducted from the soaking temperature to 200 °C in the finishing annealing while satisfying the following conditions (1) to (4):
(1) an average cooling rate in a temperature range from 700 °C to 200 °C: 10 °C/s or more;
(2) a hydrogen concentration in a furnace atmosphere gas from the soaking temperature to 700 °C: 1 vol % or more;
(3) a dew point of the furnace atmosphere gas in a temperature range from the soaking temperature to 300 °C: −30 °C or less; and
(4) a variation of a steel sheet temperature in a sheet width direction in a temperature range from 500 °C to 200 °C: 40 °C or less.

4. The method for producing a non-oriented electrical steel sheet according to claim 3, wherein
the cooling is conducted such that the difference between the maximum and minimum values of an average cooling rate every 100 °C in a temperature range from 700 °C to 200 °C during the finishing annealing is 20 °C/s or less.

5. The method for producing a non-oriented electrical steel sheet according to claim 3, wherein
the steel slab contains, in addition to the above chemical composition, at least one group selected from the following groups A to F:
group A: at least one element selected from the group consisting of Ca, Mg, and REM: 0.0010 to 0.0080 mass % in total;
group B: at least one element selected from the group consisting of Cr, Mo, Cu, and Ni: 0.01 to 0.60 mass % in total;
group C: at least one element selected from the group consisting of Ti, Nb, and V: 0.0005 to 0.0050 mass % in total;
group D: at least one element selected from the group consisting of B: 0.0001 to 0.0020 mass %, Pb: 0.0001 to 0.0010 mass %, and W: 0.0005 to 0.0050 mass %;
group E: Zn: 0.001 to 0.010 mass %; and
group F: Co: 0.0010 to 0.0500 mass %.

6. The method for producing a non-oriented electrical steel sheet according to claim 4, wherein
the steel slab contains, in addition to the above chemical composition, at least one group selected from the following groups A to F:
group A: at least one element selected from the group consisting of Ca, Mg, and REM: 0.0010 to 0.0080 mass % in total;
group B: at least one element selected from the group consisting of Cr, Mo, Cu, and Ni: 0.01 to 0.60 mass % in total;
group C: at least one element selected from the group consisting of Ti, Nb, and V: 0.0005 to 0.0050 mass % in total;
group D: at least one element selected from the group consisting of B: 0.0001 to 0.0020 mass %, Pb: 0.0001 to 0.0010 mass %, and W: 0.0005 to 0.0050 mass %;
group E: Zn: 0.001 to 0.010 mass %; and
group F: Co: 0.0010 to 0.0500 mass %.
